(19) United States
(12) Patent Application Publication
(10) Pub. No.: US 2026/0254334 A1
(43) Pub. Date: Aug. 27, 2026

(54) FOUNDATION REINFORCEMENT EQUIPMENT INTEGRATING RAMMING, VIBROFLOTATION AND MATERIAL FEEDING FUNCTIONS

(71) Applicants: ZHEJIANG UNIVERSITY OF TECHNOLOGY, Hangzhou (CN); ZHEJIANG NATURAL RESOURCES GROUP CO., LTD., Hangzhou (CN)

(72) Inventors: Mengfen SHEN, Hangzhou (CN); Zhanpu SONG, Hangzhou (CN); Zili HE, Hangzhou (CN); Kun PAN, Hangzhou (CN); Xiaodong PAN, Hangzhou (CN); Honglei SUN, Hangzhou (CN)

(21) Appl. No.: 19/537,302

(22) Filed: Feb. 11, 2026

(30) Foreign Application Priority Data
Feb. 26, 2025 (CN) 202510216895.0

(51) Int. Cl. H02K 33/16; B66C 1/36; E02D 3/12; E02D 5/44; E02D 5/56

(52) U.S. Cl. CPC H02K 33/16; B66C 1/36; E02D 3/12; E02D 5/44; E02D 5/56

(57) ABSTRACT

Foundation reinforcement equipment integrating ramming, vibroflotation and material feeding functions includes: a vertical vibroflotation module, a feeding rack, and an annular drop hammer. The vertical vibroflotation module is provided thereinside with a material delivery pipe, and has the top end provided with an open filling port communicating with the material delivery pipe, and the bottom end provided with a material discharge port communicating with the material delivery pipe. The feeding rack is located on the top outer side of the vertical vibroflotation module, and a feeding box is rotatably connected to the top of the feeding rack. Backfill material in the feeding box can be poured into the filling port by rotating the feeding box. The annular drop hammer is coaxially provided outside the vertical vibroflotation module, and has the top surface connected to the bottom surface of the feeding rack via an automatic hoisting and unlocking mechanism.

### CROSS REFERENCE TO RELATED APPLICATIONS

The present disclosure claims the priority to the Chinese patent application with the filing No. 2025102168950, entitled “FOUNDATION REINFORCEMENT EQUIPMENT INTEGRATING RAMMING, VIBROFLOTATION AND MATERIAL FEEDING FUNCTIONS” and filed on February 26, 2025 with the Chinese Patent Office, the contents of which are incorporated herein by reference in their entirety.

### TECHNICAL FIELD

The present disclosure relates to the technical field of foundation treatment and soil improvement equipment, and more specifically to foundation reinforcement equipment integrating ramming, vibroflotation and material feeding functions.

### BACKGROUND ART

Foundation treatment is a crucial step in civil engineering construction, and significantly affects the stability and safety of buildings and infrastructure. Common reinforcement methods suitable for large-area foundation include a dynamic compaction method and a vibroflotation method, where the dynamic compaction method primarily uses the impact force generated by the free fall of an object to improve compactness of a soil layer and is widely used for surface soil reinforcement; and the vibroflotation method utilizes deep vibration technology to improve the granular structure of the soil body, and shows significant advantages, particularly in the foundation treatment of collapsible soils, loose soils, and sandy soils, etc.

However, with the increasing scale of construction and the emergence of different soil body types, a single technology (such as ramming or vibroflotation method) may not achieve the ideal reinforcement effect under complex conditions. For example, the dynamic compaction method mainly works on surface soil body and has limited effect on deep soil body, and the effect is relatively poor especially in the problematic soil layer such as water-saturated area or collapsible soil. The vibroflotation method may treat deep soil body, but requires a large amount of equipment and space during construction, and the treatment effect thereof on hard soil layer is also not ideal. In addition, equipment using only one single method has poor adaptability to the environment during actual construction. When multiple processing methods need to be used in combination, multiple machines need to operate simultaneously, which greatly increases labor costs and greatly reduces work efficiency.

### SUMMARY

In view of this, the present disclosure provides foundation reinforcement equipment integrating ramming, vibroflotation and material feeding functions, aiming to solve the above-mentioned technical problems.

To achieve the above objectives, the present disclosure adopts the following technical solutions.

Foundation reinforcement equipment integrating ramming, vibroflotation and material feeding functions includes:

a vertical vibroflotation module, where the vertical vibroflotation module is provided thereinside with a material delivery pipe, the top end of the vertical vibroflotation module is provided with an open filling port in communication with the material delivery pipe, and the bottom end of the vertical vibroflotation module is provided with a material discharge port in communication with the material delivery pipe;

a feeding rack, where the feeding rack is provided at the top outer side of the vertical vibroflotation module, a feeding box is rotatably connected to the top of the feeding rack, and the backfill material in the feeding box can be poured into the filling port by rotating the feeding box; and

an annular drop hammer, where the annular drop hammer is provided coaxially outside the vertical vibroflotation module, and has the top surface connected to the bottom surface of the feeding rack through an automatic hoisting and unlocking mechanism.

Through the above technical solution, the present disclosure integrates the ramming, vibroflotation and material feeding functions into one unit, reduces equipment switching and transportation time and improves construction efficiency. It can be adapted to different geological conditions and complex soil layers, such as collapsible soil and loose soil, solving the problem of poor effect of traditional single reinforcement methods under complex conditions. By integrating multiple reinforcement functions, the collaborative operation time between construction procedures and equipment is reduced, the construction period is shortened, and construction costs are lowered.

Preferably, in the aforementioned foundation reinforcement equipment integrating ramming, vibroflotation and material feeding functions, an electrically driven movable control blade is installed at the material discharge port. The electrically driven movable control blade can precisely control the output quantity and output timing of the backfill material, ensuring uniform distribution of the backfill material and improving the foundation reinforcement effect. By electrically controlling the opening and closing of the blade, automated filling control is achieved, reducing manual intervention and improving construction accuracy and safety. The flow rate and speed of the backfill material may be flexibly adjusted according to construction requirements, to adapt to different foundation reinforcement scenarios and soil layer conditions.

Preferably, in the aforementioned foundation reinforcement equipment integrating ramming, vibroflotation and material feeding functions, the hoisting and unlocking mechanism includes an electrically controlled hook latch and a drop hammer lifting ring, the electrically controlled hook latch is installed on the bottom surface of the feeding rack, and the drop hammer lifting ring is connected to the top surface of the annular drop hammer, the drop hammer lifting ring is hung on the electrically controlled hook latch, and the electrically controlled hook latch can be controlled to be separated from the drop hammer lifting ring, to thereby release the annular drop hammer. The use of the electrically controlled hook latch enables automatic release and retrieval of the annular drop hammer, reducing the tediousness and risks of manual operation and improving construction efficiency. It can precisely control the release timing of the drop hammer, ensure accurate transmission of the ramming impact force and improve the foundation reinforcement effect. The unlocking and hooking operations of the drop hammer are achieved through the electrical control system, avoiding potential safety hazards that may arise from manual operations.

Preferably, in the aforementioned foundation reinforcement equipment integrating ramming, vibroflotation and material feeding functions, the drop hammer lifting ring is rotatably connected to the top surface of the annular drop hammer, and the annular drop hammer is provided thereinside with a motor configured to control rotation of the drop hammer lifting ring. The rotatable connection and the motor control of the drop hammer lifting ring enables flexible position adjustment of the drop hammer during the release and retrieval, ensuring the stability and accuracy of the hoisting. The rotation of the lifting ring is controlled through the motor, reducing direct friction between the lifting ring and the electrically controlled hook latch, and extending the service life of the equipment. The fast and accurate hoisting and release processes enable continuous operation of the equipment, improving construction efficiency.

Preferably, in the aforementioned foundation reinforcement equipment integrating ramming, vibroflotation and material feeding functions, the hoisting and unlocking mechanism further includes a visual alignment system. The visual alignment system can accurately identify the position of the annular drop hammer, ensure the accuracy of the hoisting and release processes, and avoid construction accidents caused by positional deviations. Through the cooperation of the visual system and the electrically controlled hook latch, fully automated hoisting and release operations are achieved, reducing manual intervention and improving construction safety and efficiency. In complex construction sites, the visual alignment system enables rapid adaptation to environmental changes, and ensure the stable operation of the equipment.

Preferably, in the aforementioned foundation reinforcement equipment integrating ramming, vibroflotation and material feeding functions, a hydraulic cylinder is connected between the top surface of the feeding rack and the feeding box, and the hydraulic cylinder can drive the feeding box to tip. The hydraulic cylinder drives the feeding box to tip to realize automatic feeding process, reduce manual operations, and improve construction efficiency. The hydraulic cylinder can precisely control the tipping angle and speed of the feeding box, to ensure that the backfill material can be accurately poured into the filling port, and improve the feeding uniformity and accuracy. The use of a hydraulic system reduces direct contact between mechanical parts, and lowers equipment failure and operational risks.

Preferably, in the aforementioned foundation reinforcement equipment integrating ramming, vibroflotation and material feeding functions, the feeding box is a funnel-shaped box body. The design of the funnel-shaped box body enables the backfill material to flow smoothly into the material delivery pipe, avoiding material accumulation and blockage and improving feeding efficiency. The funnel-shaped structure can maximally reduce the scattering and waste of the backfill material, reducing construction costs. The funnel-shaped box body can be adapted to backfill materials of different particle sizes and types, improving the versatility of the equipment.

Preferably, in the aforementioned foundation reinforcement equipment integrating ramming, vibroflotation and material feeding functions, the top surface of the feeding rack is provided with a hoisting ring. The design of the hoisting ring enables the feeding rack to be conveniently connected to a hoisting system, facilitating the hoisting and movement of the equipment and improving construction flexibility. The hoisting ring provides a stable hoisting point, ensuring the balance and safety of the equipment during hoisting, and avoiding equipment damage or accidents caused by improper hoisting. It simplifies the installation and dismantling processes of the equipment and improves the overall construction efficiency.

Preferably, in the aforementioned foundation reinforcement equipment integrating ramming, vibroflotation and material feeding functions, the bottom end of the vertical vibroflotation module is of a conical structure, and has two sides provided with protruding vibration blocks. The conical structure can effectively reduce the resistance of the vertical vibroflotation module during lowering, making it easier to penetrate the soil layer and improving the penetration capability of the equipment. The design of the vibration blocks enhances the vibration transmission efficiency, allowing vibration to act more uniformly on the soil layer and improving the foundation reinforcement effect. The combination of the conical structure and vibration blocks enables better adaptation to different types of soil layers which include hard soil layers and collapsible soil layers, improving the versatility and adaptability of the equipment.

Preferably, in the aforementioned foundation reinforcement equipment integrating ramming, vibroflotation and material feeding functions, the vertical vibroflotation module generates high-frequency vibration by using a motor to drive an eccentric block to rotate, or by using a hydraulically driven hydraulic motor as power. The hydraulic motor drives the eccentric shaft to rotate via a coupling, to thereby generate a horizontal excitation force and vibration amplitude distributed in the axial direction of the main shaft. The vibration system driven by the motor or hydraulic motor can generate high-frequency vibration, to effectively improve the granular structure of the soil layer and increase the compactness and bearing capacity of the foundation. The use of a hydraulic power system provides strong power support, ensuring the stable operation of the vibration system, and is particularly suitable for the reinforcement of deep soil layers. The vibration frequency and vibration amplitude may be flexibly adjusted according to soil layer conditions and construction requirements to achieve precise reinforcement, improving the adaptability and the construction effect of the equipment.

As can be seen from the above technical solutions, compared with the prior art, the present disclosure provides foundation reinforcement equipment integrating ramming, vibroflotation and material feeding functions, which has the following beneficial effects.
1. The equipment integrates ramming and vibroflotation methods, and can complete multiple reinforcement tasks within a single workflow, greatly improving construction efficiency. Compared to the traditional methods in which multiple devices are required to work alternately, the equipment reduces equipment switching and transportation time, thus accelerating project progress.
2. With an integrated intelligent control system, the equipment can automatically adjust the ramming impact force and vibration frequency according to soil body conditions and operational requirements, achieving precise control. The system can provide real-time feedback on the soil body reinforcement effect and automatically optimize operating parameters to ensure that the reinforcement effect at each step meets design requirements.
3. Traditional equipment often suffers from the problems of low collaborative operation efficiency and power waste. The design of the equipment adopts an intelligent collaborative control system, which allows the ramming, vibrating and grouting components to switch smoothly and work together, greatly improving energy utilization efficiency and reducing unnecessary energy waste.
4. The design of the equipment considers various complex soil layers, enabling flexible adjustment of operating parameters according to compactness and bearing capacity requirements of the soil layer to ensure optimal reinforcement effect. Furthermore, the equipment is highly adaptable to geotechnical engineering and suitable to be used in projects under different environmental conditions.
5. Intelligent control and automated workflow greatly reduce the possibility of manual intervention and operational mistakes. Operators only need to set relevant parameters and monitor remotely, and the equipment can automatically complete complex reinforcement tasks, thereby significantly reducing labor costs and improving the safety and precision of construction.
6. The equipment has a comprehensive safety design, in which multiple safety safeguards including overload protection, vibration isolation, and protective devices are provided, to ensure that the operators can be fully protected even in complex working environments. Meanwhile, the intelligent detection system can monitor the operating state of the equipment in real time, providing timely feedback and taking measures to avoid occurrence of accidents.

### BRIEF DESCRIPTION OF DRAWINGS

To more clearly illustrate the technical solutions in the embodiments of the present disclosure or in the prior art, the drawings required to be used in the description of the embodiments or the prior art will be briefly introduced below. Obviously, the drawings described below are only embodiments of the present disclosure. For those ordinarily skilled in the art, other drawings may be obtained based on the provided drawings without paying creative effort.

FIG. 1 is a structural schematic view of foundation reinforcement equipment integrating ramming, vibroflotation and material feeding functions provided by the present disclosure.

FIG. 2 is a structural schematic view of a feeding rack provided by the present disclosure;

FIG. 3 is a structural schematic view of a vertical vibroflotation module provided by the present disclosure;

FIG. 4 is a structural schematic view of an annular drop hammer provided by the present disclosure;

FIG. 5 is a schematic view of the internal structure of the annular drop hammer provided by the present disclosure; and

FIG. 6 is a schematic view of the internal structure of the vertical vibroflotation module provided by the present disclosure.

### In the above

1-vertical vibroflotation module; 2-feeding rack; 3-annular drop hammer; 4-filling port; 5-feeding box; 6-automatic hoisting and unlocking mechanism; 7-electrically controlled hook latch; 8-drop hammer lifting ring; 9-motor; 10-hydraulic cylinder; 11-hoisting ring; 12-vibration block; 13-outer tube; 14-inner chamber; 15-connecting rod.

### DETAILED DESCRIPTION OF EMBODIMENTS

The technical solutions in the embodiments of the present disclosure will be clearly and completely described below in conjunction with the drawings in the embodiments of the present disclosure. Obviously, the described embodiments are only some embodiments of the present disclosure, and not all embodiments. Based on the embodiments of the present disclosure, all other embodiments obtained by those ordinarily skilled in the art without paying creative effort fall within the scope of protection of the present disclosure.

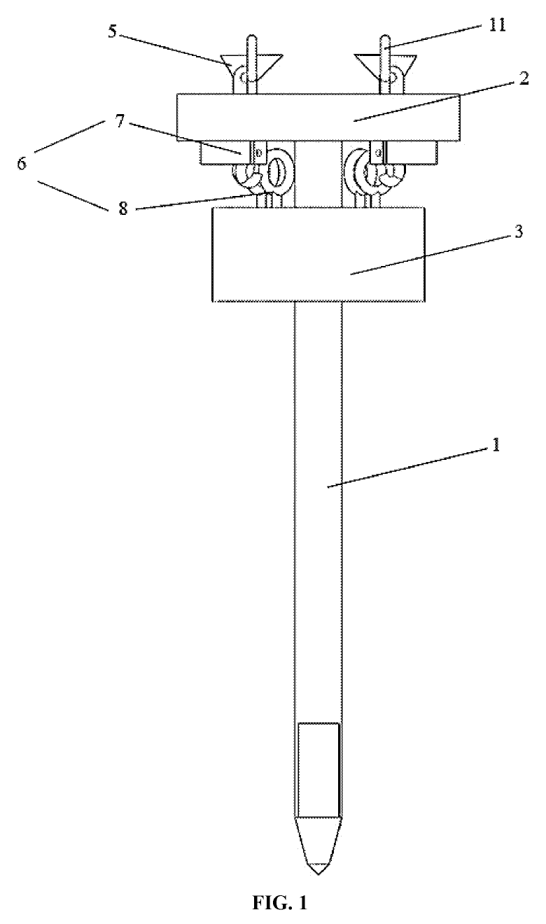

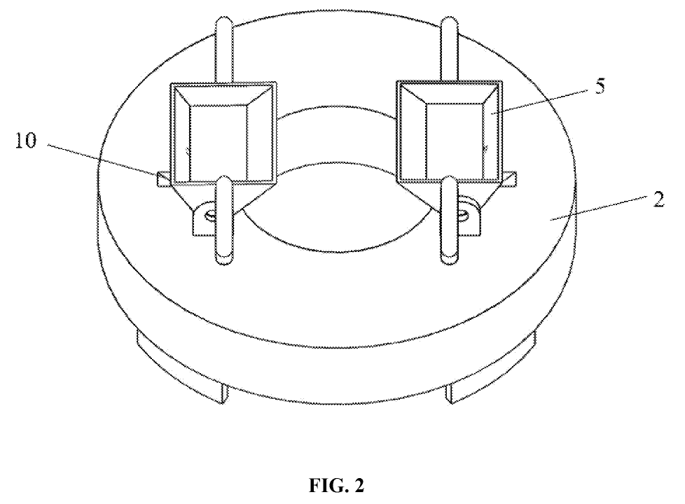

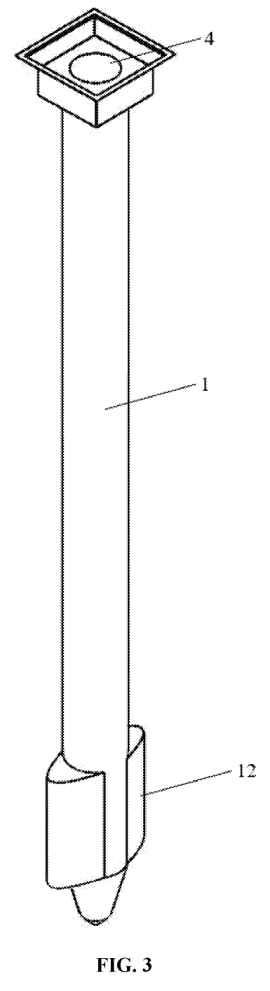

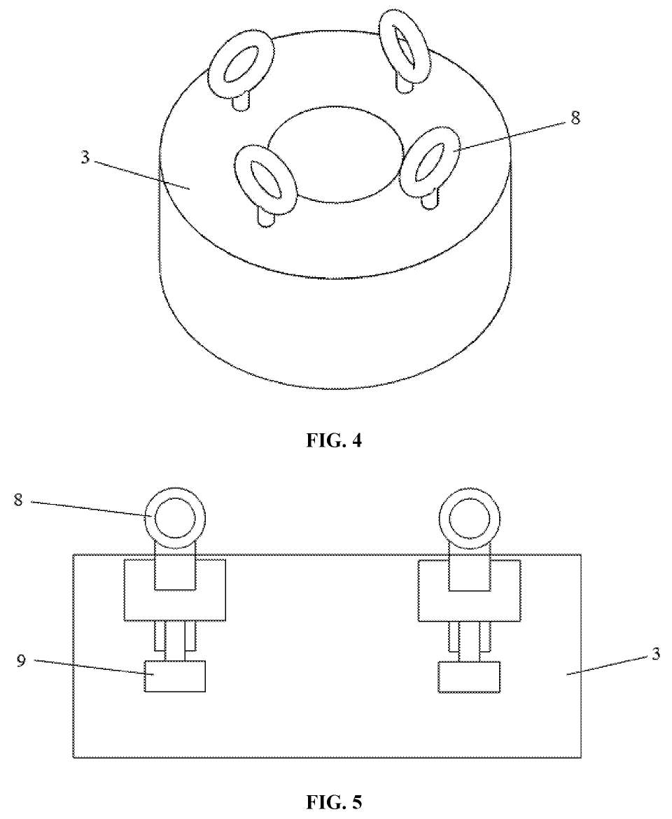

Referring to FIGS. 1 to 5, embodiments of the present disclosure disclose foundation reinforcement equipment integrating ramming, vibroflotation and material feeding functions, including:

a vertical vibroflotation module 1, where the vertical vibroflotation module 1 is provided thereinside with a material delivery pipe, the top end of the vertical vibroflotation module 1 is provided with an open filling port 4 in communication with the material delivery pipe, and the bottom end of the vertical vibroflotation module 1 is provided with a material discharge port in communication with the material delivery pipe;

a feeding rack 2, where the feeding rack 2 is provided at the top outer side of the vertical vibroflotation module 1, a feeding box 5 is rotatably connected to the top of the feeding rack 2, and the backfill material in the feeding box 5 can be poured into the filling port 4 by rotating the feeding box 5; and

an annular drop hammer 3, where the annular drop hammer 3 is provided coaxially outside the vertical vibroflotation module 1, and has the top surface connected to the bottom surface of the feeding rack 2 through an automatic hoisting and unlocking mechanism 6.

To further optimize the above technical solution, an electrically driven movable control blade is installed on the material discharge port.

To further optimize the above technical solution, the hoisting and unlocking mechanism 6 includes an electrically controlled hook latch 7 and a drop hammer lifting ring 8, the electrically controlled hook latch 7 is installed on the bottom surface of the feeding rack 2, the drop hammer lifting ring 8 is connected to the top surface of the annular drop hammer 3, the drop hammer lifting ring 8 is hung on the electrically controlled hook latch 7, and the electrically controlled hook latch 7 can be controlled to be separated from the drop hammer lifting ring 8, thereby releasing the annular drop hammer 3.

The electrically controlled hook latch 7 provided in this embodiment may be an Elebia evo series smart lifting hook, a NEO series lifting hook, or a Demag quadro chain hoist, all of which are conventional structures in the prior art and will not be described in detail here.

To further optimize the above technical solution, the drop hammer lifting ring 8 is rotatably connected to the top surface of the annular drop hammer 3, and the annular drop hammer 3 is provided thereinside with a motor 9 for controlling rotation of the drop hammer lifting ring 8.

To further optimize the above technical solution, the hoisting and unlocking mechanism 6 further includes a visual alignment system.

To further optimize the above technical solution, a hydraulic cylinder 10 is connected between the top surface of the feeding rack 2 and the feeding box 5, and the hydraulic cylinder 10 can drive the feeding box 5 to tip.

To further optimize the above technical solution, the feeding box 5 is a funnel-shaped box body.

To further optimize the above technical solution, the top surface of the feeding rack 2 is provided with a hoisting ring 11.

To further optimize the above technical solution, the bottom end of the vertical vibroflotation module 1 is of a conical structure, and has two sides provided with protruding vibration blocks 12.

To further optimize the above technical solution, the vertical vibroflotation module 1 generates high-frequency vibration by using a motor to drive an eccentric block to rotate, or by using a hydraulically driven hydraulic motor as power, and the hydraulic motor drives the eccentric shaft to rotate through a coupling, to thereby generate a horizontal excitation force and vibration amplitude distributed in the axial direction of the main shaft.

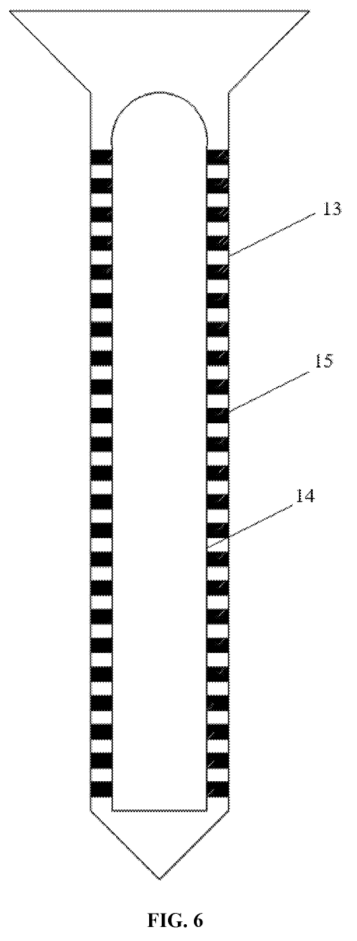

Referring to FIG. 6, this embodiment provides a schematic view of the internal structure of the vertical vibroflotation module 1. The vertical vibroflotation module 1 consists of an outer tube 13 and an inner chamber 14. The gap between the outer tube 13 and the inner chamber 14 is the material delivery pipe. The outer tube 13 and the inner chamber 14 are fixed to each other by multiple connecting rods 15 to improve strength, and the connecting rods 15 do not affect the material delivery. The inside of the inner chamber 14 is used to install the components required for vibroflotation.

The equipment in this embodiment is equipped with an intelligent control system, including a data acquisition module and a data processing module, to achieve precise control of the working process.

Data acquisition module: collecting soil layer parameter data through underground sensors (such as pressure sensors and vibration sensors). The sensors are arranged inside the ramming and vibroflotation modules and near the material feeding module to obtain data such as soil layer compactness, porosity, soil body bearing capacity, and vibration response in real time.

Data processing module: transmitting the collected underground data to the central processing system, which system performs real-time analysis and prediction of the soil body reinforcement effect based on a preset algorithm. The system can calculate the bearing capacity and reinforcement requirements of the current soil body, and precisely regulate and control parameters such as ramming impact energy, vibroflotation frequency, and the grouting volume to ensure maximum reinforcement effect.

Installation and preparation of the equipment provided in this embodiment

Determination of reinforcement points: determining, based on construction drawings or on-site survey, points where the reinforcement is required, and marking the grouting holes, backfill points, and compaction areas.

Installation of the equipment: placing the equipment above a predetermined reinforcement point through a hoisting system, and ensuring that the equipment is level and all components are intact.

### Operating steps

1. Starting of a hoisting motor:

The hoisting motor is started and the vertical vibroflotation module 1 is slowly lowered to the predetermined depth.

It is ensured that the vibratory head has been started and is in vibration mode, and drilling and excavation operations are started.

At the same time, the feeding rack 2 is lowered to a certain height along with another hoist cable, and another excavator pours the required backfill sand soil into the rotatable feeding box 5 of the feeding rack 2.

2. Vibration and feeding:

Once the vertical vibroflotation module 1 reaches the predetermined depth, the vertical vibroflotation module 1 activates and opens the movable blade at the bottom and continuously vibrates to improve the soil body structure.

At the same time, the hydraulic cylinder 10 is activated, the feeding box 5 is rotated, and filing of the backfill material is started.

3. Vibration backfilling and adjustment:

Once the backfill material reaches a certain depth, the vertical vibroflotation module 1 moves upwards a certain distance to ensure the compactness and uniformity of the reinforcement layer.

The vibration continuously acts to enhance the combination of the backfill material and the soil body to improving the bearing capacity of the soil body.

### Drop hammer reinforcement

1. When the electrically controlled hook latch 7 is released, the annular drop hammer 3 falls freely, to generate powerful hammering energy to compact the soil body. 3 back and lifts the annular drop hammer 3 upwards for the next compaction.
2. The hoisting system is started to slowly lower the feeding rack 2, and a visual recognition system is used to accurately position the annular drop hammer 3. Once the annular drop hammer 3 is in place, manual aligning is performed by the camera installed below the feeding rack 2, and then the electrically controlled hook latch 7 hooks the annular drop hammer
3. Repeating of operations:

As required in the project, the above operation steps are repeated: vibration, backfilling, and drop hammer reinforcement.

Individual mechanisms may be started independently or be used flexibly and alternately as needed, providing a variety of reinforcement combinations to ensure the best reinforcement effect under different soil conditions.

Independent operation and cooperative use of the equipment

Individual operation: individual reinforcement methods (vibration, dynamic compaction) may be performed independently as needed, and users can choose the most suitable reinforcement method according to the soil body type, depth requirements, etc.

In this specification, the embodiments are described in a progressive manner, and each embodiment focuses on the differences from other embodiments. The same or similar parts between the embodiments may be referred to each other. For the device disclosed in the embodiment, since it corresponds to the method disclosed in the embodiment, the description is relatively simple, and the relevant parts may be referred to the method parts.

The above description of the disclosed embodiments enables one skilled in the art to implement or use the present application. Various modifications to these embodiments will be obvious to one skilled in the art, and the general principles defined herein may be implemented in other embodiments without departing from the spirit or scope of the present disclosure. Therefore, the present application will not be limited to the embodiments shown herein, but rather will conform to the widest scope consistent with the principles and novel features disclosed herein.

1. Foundation reinforcement equipment integrating ramming, vibroflotation and material feeding functions, comprising:
a vertical vibroflotation module, wherein the vertical vibroflotation module is provided thereinside with a material delivery pipe, a top end of the vertical vibroflotation module is provided with an open filling port in communication with the material delivery pipe, and a bottom end of the vertical vibroflotation module is provided with a material discharge port in communication with the material delivery pipe;
a feeding rack, wherein the feeding rack is provided at a top outer side of the vertical vibroflotation module, and a feeding box is rotatably connected to a top of the feeding rack, wherein a backfill material in the feeding box can be poured into the filling port by rotating the feeding box; and
an annular drop hammer, wherein the annular drop hammer is provided coaxially outside the vertical vibroflotation module, and has a top surface connected to a bottom surface of the feeding rack through an automatic hoisting and unlocking mechanism.

2. The foundation reinforcement equipment integrating ramming, vibroflotation and material feeding functions according to claim 1, wherein an electrically driven movable control blade is installed on the material discharge port.

3. The foundation reinforcement equipment integrating ramming, vibroflotation and material feeding functions according to claim 1, wherein the hoisting and unlocking mechanism comprises an electrically controlled hook latch and a drop hammer lifting ring, the electrically controlled hook latch is installed on a bottom surface of the feeding rack, the drop hammer lifting ring is connected to a top surface of the annular drop hammer, the drop hammer lifting ring is hung on the electrically controlled hook latch, and the electrically controlled hook latch is configured to be controlled to be separated from the drop hammer lifting ring to thereby release the annular drop hammer.

4. The foundation reinforcement equipment integrating ramming, vibroflotation and material feeding functions according to claim 3, wherein the drop hammer lifting ring is rotatably connected to the top surface of the annular drop hammer, and a motor configured to control rotation of the drop hammer lifting ring is provided inside the annular drop hammer.

5. The foundation reinforcement equipment integrating ramming, vibroflotation and material feeding functions according to claim 4, wherein the hoisting and unlocking mechanism further comprises a visual alignment system.

6. The foundation reinforcement equipment integrating ramming, vibroflotation and material feeding functions according to claim 1, wherein a hydraulic cylinder is connected between a top surface of the feeding rack and the feeding box, and the hydraulic cylinder is configured to drive the feeding box to tip.

7. The foundation reinforcement equipment integrating ramming, vibroflotation and material feeding functions according to claim 1, wherein the feeding box is a funnel-shaped box body.

8. The foundation reinforcement equipment integrating ramming, vibroflotation and material feeding functions according to claim 1, wherein a top surface of the feeding rack is provided with a hoisting ring.

9. The foundation reinforcement equipment integrating ramming, vibroflotation and material feeding functions according to claim 1, wherein the bottom end of the vertical vibroflotation module is of a conical structure and has two sides provided with protruding vibration blocks.

10. The foundation reinforcement equipment integrating ramming, vibroflotation and material feeding functions according to claim 1, wherein the vertical vibroflotation module is configured to generate high-frequency vibration by using a motor to drive an eccentric block to rotate, or by using a hydraulically driven hydraulic motor as power, wherein the hydraulic motor is configured to drive an eccentric shaft to rotate through a coupling, to thereby generate a horizontal excitation force and vibration amplitude distributed in an axial direction of a main shaft.
